(19) United States
(12) Patent Application Publication
(10) Pub. No.: US 2004/0171724 A1
(43) Pub. Date: Sep. 2, 2004

(54) Polyolefin compositions exhibiting enhanced stain resistance

(76) Inventors: Steven D. Seip, Erie, PA (US); Edwin B. Townsend IV, Pittsburgh, PA (US); Sehyun Kim, Murraysville, PA (US); Leslie A. Bockman, Canonsburg, PA (US)

Correspondence Address: Robert A. Koons, Jr., Buchanan Ingersoll, P.C., 14th Floor, 1835 Market Street, Philadelphia, PA, 19103-2985, US

(21) Appl. No.: 10/673,791

(22) Filed: Sep. 29, 2003

Related U.S. Application Data
(60) Provisional application No. 60/414,790, filed on Sep. 30, 2002.

(51) Int. Cl. C08K 5/51

(52) U.S. Cl. 524/128; 524/451; 524/394

(57) ABSTRACT

The present invention provides polyolefin household articles exhibiting enhanced stain resistance. The household articles according to the current invention include housewares, such as bowls, cups, containers and utensils, as well as, components for household appliances such as: dishwashers, washing machines and refrigerators. The household articles according to the current invention comprise a polypropylene homopolymer or impact copolymer having enhanced resistance to staining on contact with food or other articles soiled with food. The articles according to the current invention attained enhanced stain resistance through a combination of control of the properties of the propylene polymers and balance of additives.

### RELATED APPLICATIONS

This application claims priority to provisional application serial No. 60/414,790 filed on Sep. 30, 2002, the contents of which are incorporated herein by reference in their entirety.

### FIELD OF THE INVENTION

The present invention is drawn to the field of polyolefins and articles produced from polyolefins. More specifically, the present invention is drawn to a method of producing polyolefin compositions exhibiting enhanced stain resistance and polyolefin articles made from those compositions.

### BACKGROUND OF THE INVENTION

As the use of plastic in housewares and parts for appliances has grown, staining of these articles has become of increasing concern. Plastics have been used increasingly in applications where staining from contact with food is especially problematic. There are several areas in particular where staining from contact with food is an issue. First, in the area of housewares such as plates, bowls and utensils, articles may become stained during storage and reheating of food. Second, in the area of appliances for food storage, such as refrigerators and freezers, polyolefin parts may become stained from food that spills or leaks onto the parts. Thirdly, in the area of cleaning appliances, such as dishwashers and washing machines, the combination of heat and contact with food and dirt from soiled items may lead to staining of polyolefin parts in these appliances.

In general, the type of staining that results from contact with foods does not compromise the integrity of the polyolefin article. However, such staining is considered unsightly and detracts from the aesthetic appearance of the houseware or appliance. In the case of appliances, such staining may adversely affect the resale value of the appliance. There are currently few if any polymers on the market that provide an adequate level of stain resistance in any of these articles.

In addition to stain resistance, a desirable quality in polyolefins used for household articles and appliances is impact resistance over a wide range of temperatures. Containers and utensils used for food storage and handling may experience temperatures varying from the freezer to the microwave or dishwasher. Likewise, dishwasher and washing machine parts experience high temperatures and vigorous impacts.

It would therefore be desirable to provide a method for producing stain resistant polyolefin compositions that can be fashioned into housewares and parts for household appliances. Such polyolefins would resist staining by food during storage and reheating when used for housewares. Such polyolefins would also resist staining when used in appliances such as dishwashers and washing machines that are exposed to high temperatures in addition to food. Such polyolefins would further display good impact resistance over a wide range of temperatures.

### SUMMARY OF THE INVENTION

In general, the present invention provides polyolefin compositions that display enhanced resistance to staining when used in household articles. The general term household articles encompasses housewares such as: bowls, cups, containers and utensils, as well as, components for household appliances such as: dishwashers, washing machines and refrigerators. In general, the polyolefin compositions according to the current invention will be useful in any household article that is susceptible to staining through contact with food or other items that are soiled with food. The polyolefin compositions according to the current invention also resist staining by contact with food when exposed to high temperatures.

The polyolefin compositions according to the current invention may comprise propylene homopolymers or propylene/ethylene impact copolymers, depending upon the application in which the composition is to be used. Impact copolymers are preferred in such applications as dishwashers, washing machines, refrigerators and other appliances that may experience impacts over a wide temperature range. Impact copolymers may also be preferred in household articles such as bowls and food containers that experience wide temperature ranges.

More particularly, according to one embodiment the present invention provides components for household appliances that exhibit enhanced resistance to staining. The molded components according to this aspect of the invention comprise either: a propylene homopolymer having a crystallinity of at least about 55 percent, or a nucleated propylene/ethylene impact copolymer having an ethylene content of up to about 15 percent by weight, and a xylene solubles fraction having an intrinsic viscosity of at least 3 dL/g. The xylene soluble fraction further has a molecular weight (Mw/1000) of at least about 350. In either case, the propylene polymer contains an additive package consisting essentially of: a phenolic antioxidant, a phosphite, and an acid scavenger. The propylene polymer optionally further contains a thiosynergist for certain applications. An important aspect of the current invention is that the composition and the molded components made therefrom are essentially free of sodium containing additives.

According to another embodiment, the present invention provides a molded houseware article exhibiting enhanced stain resistance. The molded houseware article may comprise either: a propylene homopolymer having a crystallinity of at least about 55 percent, or a nucleated propylene/ethylene impact copolymer having an ethylene content of up to about 15 percent by weight, and a xylene solubles fraction having an intrinsic viscosity of at least 3 dL/g, wherein the xylene soluble fraction has a molecular weight (Mw/1000) of at least about 350. In either case, the propylene polymer contains an additive package consisting essentially of: a phenolic antioxidant, a phosphite, and an acid scavenger. The propylene polymer optionally further contains a thiosynergist for certain applications. Again, the houseware article is essentially free of sodium containing additives.

The present invention also provides methods for producing both components for household appliances and houseware articles displaying enhanced stain resistance.

### BRIEF DESCRIPTION OF THE DRAWINGS

FIG. 1 is a bar graph of copolymer Δ E values (Heinz Ketchup)

FIG. 2: is a bar graph of homopolymer Δ E values (Heinz Ketchup)

FIG. 3: is a bar graph of copolymer Δ E values (Giant Eagle Ketchup)

FIG. 4: is a bar graph of homopolymer Δ E values (Giant Eagle Ketchup)

FIG. 5: is a bar graph of copolymer Δ E values (KC Masterpiece Barbecue)

FIG. 6: is a bar graph of homopolymer Δ E values (KC Masterpiece Barbecue)

FIG. 7: is a bar graph of copolymer Δ YI values (Heinz Ketchup)

FIG. 8: is a bar graph of homopolymer Δ YI values (Heinz Ketchup)

FIG. 9: is a bar graph of copolymer Δ a values (Heinz Ketchup)

FIG. 10: is a bar graph of homopolymer Δ a values (Heinz Ketchup)

FIG. 11: is a bar graph of copolymer Δ YI values (Giant Eagle Ketchup)

FIG. 12: is a bar graph of homopolymer Δ YI values (Giant Eagle Ketchup)

FIG. 13: is a bar graph of copolymer Δ a values (Giant Eagle Ketchup)

FIG. 14: is a bar graph of homopolymer Δ a values (Giant Eagle Ketchup)

FIG. 15: is a bar graph of copolymer Δ YI values (KC Masterpiece Barbeque)

FIG. 16: is a bar graph of homopolymer Δ YI values (KC Masterpiece Barbecue)

FIG. 17: is a bar graph of copolymer Δ a values (KC Masterpiece Barbeque)

FIG. 18: is a bar graph of homopolymer Δ a values (KC Masterpiece Barbeque)

### DETAILED DESCRIPTION OF THE INVENTION

The present invention provides articles for use as housewares or components for household appliances, polyolefin compositions for producing said articles and a method for optimizing the stain resistance of said polyolefin compositions. According to one embodiment, the compositions and articles according to the current invention show a balance of stain resistance and impact resistance.

The inventors have discovered that a number of factors affect the stain resistance of polyolefin compositions. In general, higher crystallinity homopolymers display better stain resistant characteristics than copolymers. Copolymers, which generally have a higher content of solubles, experience worse staining, but have better impact resistance. Although copolymers cannot match the stain resistant qualities of homopolymers, the stain resistance of copolymers can be maximized by controlling the qualities of the solubles. Additionally, it has been discovered that the stain resistance of any polymer can be optimized by the proper combination of a nucleating agent with antioxidants and other stabilizers. A preferred nucleating agent is talc.

Additionally, it has been found that certain additives are detrimental to stain resistance. In general, glycerol mono-stearate degrades the stain resistant characteristics of the polyolefins and articles produced therefrom. Also, sodium containing compounds have been found to be detrimental to stain resistance.

### Impact Copolymers

According to a first embodiment of the current invention, polyolefin compositions for use in components for housewares and household appliances, and housewares and components fabricated from said compositions are provided. The compositions according to this embodiment of the invention are nucleated propylene/ethylene impact copolymers. While not wishing to be bound by theory, the inventors believe that the increased crystallinity imparted by the addition of nucleating agents improves the stain resistance of the impact copolymers, while maintaining the other desirable qualities of impact copolymers. Preferably, the impact copolymers according to the current invention contain from about 1000 to about 3000 ppm of a nucleating agent. The nucleating agents used according to this embodiment of the invention are essentially free of sodium. The preferred nucleating agent according to this embodiment of the invention is talc.

The impact copolymers according to this embodiment of the invention comprise up to about 15 percent by weight of ethylene. Further, the xylene soluble fraction of the impact copolymers according to the current invention has an intrinsic viscosity of at least 3 dL/g. A higher intrinsic viscosity (IV) is indicative of a higher molecular weight. Still further, the xylene soluble fraction has a molecular weight (Mw/1000) of at least about 350, preferably at least about 400.

In addition to a nucleating agent, the impact copolymers according to the current invention are stabilized with an additive package consisting essentially of: a phenolic antioxidant, a phosphite, and an acid scavenger. The additives used are essentially free of sodium. Preferably, the impact copolymers according to the current invention contain from about 500 to about 1000 ppm of a phenolic antioxidant, from about 500 to about 800 ppm of a phosphite, and from about 200 to about 500 ppm of an acid scavenger. In general, the impact copolymers according to this embodiment of the invention are essentially free of sodium containing compounds. In a more preferred embodiment, the impact copolymers according to the current invention also contain up to 5000 ppm of a thiosynergist.

### Crystalline Homopolymers

According to a second embodiment of the current invention, polyolefin compositions comprising propylene homopolymers are provided. The compositions according to this embodiment can be employed in applications for housewares and components for household appliances where the impact properties of ethylene/propylene copolymers are not required. The propylene homopolymers according to this embodiment have a crystallinity of at least 55 percent, preferably at least 60 percent.

The homopolymers according to the current invention are stabilized with an additive package consisting essentially of: a phenolic antioxidant, a phosphite, and an acid scavenger. The additives used are essentially free of sodium. Preferably, homopolymers according to the current invention contain from about 500 to about 1000 ppm of a phenolic antioxidant, from about 500 to about 800 ppm of a phosphite, and from about 200 to about 500 ppm of an acid scavenger. In general, the homopolymers according to this embodiment of the invention are essentially free of sodium containing compounds. In a more preferred embodiment, the homopolymers according to the current invention also contain up to 5000 ppm of a thiosynergist.

The present invention is demonstrated below by means of examples. These examples are for illustrative purposes and should not be construed as limiting the scope of the invention.

In a preliminary study, various polypropylene compounds were formulated as given in Tables I and II. The base materials chosen were Sunoco 5000 series propylene/ethylene copolymers and high crystalline propylene homopolymers, F350HC and F600HC. These materials were selected based primarily on their solubles level. The 5000 series materials have relatively low solubles levels in the homopolymer phase, while Sunoco TI4350P having higher than 10% xylene solubles was used for comparison. Sunoco F600HC was selected because it has the lowest solubles level among the available Sunoco polypropylene.

TABLE I
Properties of base polymer

| Powder | Melt Flow | Xylene Solubles | IV of Xylene | Ethylene |
|---|---|---|---|---|
| Type | g/10 min | Wt. % | Solubles dl/g | Wt. % |
| TI4350P | 35 | 11.5 | 2 | 5.7 |
| TI5150C | 15 | 5.5 | 6 | 2.6 |
| TI5350M | 35 | 5.5 | 6 | 2.7 |
| TI5600M | 65 | 5.5 | 6 | 2.3 |
| F350HC | 35 | 1 | — | — |
| F600HC | 60 | 1 | — | — |

Additive packages using various types of nucleators employed are shown in Table II. Comparative examples including glycerol monostearate are also shown in Table II. All of the compositions contained 500 ppm each of Irganox 1010® (pentaerythritol tetrakis(3-(3,5-di-tert-butyl-4-hydroxyphenyl)propionate) and Irgafos 168® (tris(2,4-ditert-butylphenyl)phosphite), both available from Ciba Specialty Chemicals. In addition, all of the samples contained 500 ppm of calcium stearate.

TABLE II
Additive Formulation
Stain Resistant Additive Compositions

| | | NA-11 | Talc | NaBz. | GMS |
|---|---|---|---|---|---|
| Sample | Powder | Wt. % | Wt. % | Wt. % | Wt. % |
| A | TI4350P | | | 0.1 | |
| B | TI5350M | 0.1 | 0.3 | | |
| C | TI5150C | | | | |
| D | TI5600M | | | | |
| E | TI5150C | | | | 0.5 |
| F | TI5150C | | 0.3 | | |
| G | TI5150C | | 0.3 | | 0.5 |
| H | TI5150C | | | 0.3 | |
| I | TI5150C | | | 0.3 | 0.5 |
| J | TI5150C | 0.1 | 0.3 | | |
| K | TI5150C | 0.1 | 0.3 | | 0.5 |
| L | TI5150C | 0.1 | | | |
| M | TI5150C | 0.1 | | | 0.5 |
| N | F600HC | | | | |
| O | F600HC | | | | 0.5 |
| P | F600HC | | 0.3 | | |
| Q | F600HC | | 0.3 | | 0.5 |
| R | F600HC | | | 0.3 | |
| S | F600HC | | | 0.3 | 0.5 |
| T | F600HC | 0.1 | 0.3 | | |
| U | F600HC | 0.1 | 0.3 | | 0.5 |
| V | F600HC | 0.1 | | | |
| W | F600HC | 0.1 | | | 0.5 |

All compositions have 0.05 wt % of Irganox 1010, Irgafos 168 and Calcium Stearate

The crystallinity of each polymer was determined using a typical annealed differential scanning calorimeter (Perkin-Elmer Pyris 1 DSC). The material was heated to 200° C., held for 5 min, then cooled at a rate of 10° C./min to 0° C. The sample was then heated again at a rate of 15° C./min up to 200° C. During this scan, heat flows are tracked to determine thermal transitions of the material. The amount of heat flow was used to determine the percent crystallinity of a sample. The solubles in each polymer were determined by extraction with xylenes. The intrinsic viscosity of the xylene soluble fraction for each polymer was determined by dissolving 0.02 grams of material in 20 mL of tetralin (1,2,3,4-tetrahydronaphthalene). The efflux time for the solvent and solution for each sample were determined using a Bischoff viscometer.

The samples for the staining test were produced using a 55-ton Cincinnati injection-molding machine. The process parameters for the compounds were set in accordance with ASTM D4101.

The injection-molded plaques (1 per material type) were fabricated, brushed with a staining agent, and then baked in an oven at 200° F. for two hours. The plaques were then removed from the oven and the staining agent was washed off in hot water. The resultant discoloration was evaluated using a calorimeter. Three staining agents were used: Heinz brand ketchup, Giant Eagle brand ketchup, and KC Masterpiece brand barbecue sauce. It was found that the different staining agents result in different degree of staining for each sample plaque.

The stained samples were evaluated using a Hunterlab Colorimeter. For each sample, a non-stained and a stained plaque were analyzed for L, a, b, and YI color values, from which a Δ E value was calculated. The plaques were analyzed with a white tile backing, to prevent the projected light from escaping. Due to the more translucent nature of a homopolymer sample, the calculated YI values for a homopolymer are more affected by the background than copolymer samples. Therefore, it should be noticed that a comparison of YI values between homopolymers and copolymers could be misleading. On the other hand, the Δ E values should not be affected because the Δ E value is synonymous with change in color between a standard sample and the sample in question. Δ E is calculated by taking the square root of the addition of squares for the Δ L, Δ a, and Δ b values between the standard sample and the stained sample.

### Homopolymers vs. Copolymers

A comparison between homopolymer and copolymers is given in Table III. The results shown are for samples N, D and C respectively, as shown in Table II. All three of these samples were formulated without a nucleating agent. The Δ E data show that homopolymers are significantly more resistant to the staining agents than copolymers.

TABLE III
Effect of the type of polymer

| | F600HC | Ti5600M | TI5150C |
|---|---|---|---|
| MFR | 60 | 65 | 15 |
| % XS | 1 | 5.5 | 5.5 |
| % C2 | 0 | 2.3 | 2.3 |
| % Xc | 65.1 | — | 56.3 |
| ΔE (ΔYI) - Heinz Ketchup | 3.99 (9.43) | 7.35 (17.02) | 2.32 (5.31) |
| ΔE (ΔYI) - Giant Eagle | 1.44 (3.33) | 3.69 (8.55) | 4.08 (9.31) |
| Ketchup | | | |
| ΔE (ΔYI) - KC BBQ | 1.78 (3.82) | 2.67 (6.13) | 3.35 (7.65) |

### Use of Nucleating Agents

Table IV gives annealed differential scanning calorimetry (ADSC) results and stain resistance for a homopolymer and copolymer, both formulated with various nucleating agents. The nucleating agents employed in this study were NA-11 (Sodium 2,2-methylene-bis-(4,6-di-tert-butylphenyl phosphate)), talc, sodium benzoate and a combination of NA-11 and talc. As given in Table IV, the presence of NA-11 provides the highest recrystallization temperature and crystallinity.

TABLE IV
Effect of Nucleator

| polymer | nucleator | Wt % | Tm | Tc | Xc | ΔE Heinz | ΔE Giant | ΔE BBQ |
|---|---|---|---|---|---|---|---|---|
| F600HC | none | — | 163.2 | 116.2 | 65.1 | 3.99 | 1.44 | 1.78 |
| | NA11 | 0.1 | 166 | 127.1 | 67.2 | 4.00 | 2.45 | 1.54 |
| | talc | 0.3 | 166.1 | 126.7 | 66.2 | 2.12 | 1.37 | 1.72 |
| | Na11/talc | 0.1/0.3 | 166.3 | 127.2 | 66.6 | 2.00 | 1.81 | 1.65 |
| | NaBz | 0.3 | 166.1 | 125.4 | 64.4 | 3.77 | 2.44 | 2.16 |
| TI5150 | none | — | 163.6 | 114.4 | 56.3 | 2.32 | 4.08 | 3.35 |
| | NA11 | 0.1 | 166.8 | 129.1 | 58.9 | 3.75 | 6.49 | 3.34 |
| | talc | 0.3 | 165.7 | 124 | 57.8 | 4.34 | 3.23 | 2.96 |
| | Na11/talc | 0.1/0.3 | 166.1 | 125.5 | 58.6 | 5.98 | 3.49 | 3.12 |
| | NaBz | 0.3 | 1661 | 125.4 | 58.6 | 4.71 | 5.26 | 4.24 |

*NaBz (sodium benzoate)

As can be seen from the data in Table IV, in general, the presence of a nucleator tends to enhance the stain resistance of the material. As expected from the trials without a nucleating agent, the homopolymer performs better than the copolymer. It is also apparent that certain nucleating agents are better than others. Of the nucleating agents used in the examples, talc is the most effective with respect to decreasing Δ E values. The presence of a sodium compound, such as NA-11 and sodium benzoate appears to be ineffective at best despite increased crystallinity. In most cases the presence of sodium compounds appears to be detrimental.

### The Effect of Glycerol Mono-Stearate

Table V shows the effect of Glycerol Mono-Stearate (GMS) on the degree of staining of homopolymer. GMS is commonly used as a slip agent in polyolefins. As can be seen from the data in Table V, the addition of GMS to any of the samples significantly increased the degree of staining. It is thought that this type of additive would migrate to the surface and potentially change surface chemistry, hopefully reducing staining. However, as the data indicate, the GMS actually makes staining worse. Without wishing to be bound by theory, it appears that there is an interaction between the GMS and food-staining agents. As a result, the staining was aggravated. The same trend has been obtained from the copolymers as given in Tables VI, VII and VIII.

TABLE V
Effect of GMS on staining

| | | | ΔE | ΔE | ΔE |
|---|---|---|---|---|---|
| polymer | nucleator | GMS | Heinz | Giant | BBQ |
| F600HC | none | no | 3.99 | 1.44 | 1.78 |
| | none | yes | 7.34 | 7.09 | 2.98 |
| | NA11 | no | 4.00 | 2.45 | 1.54 |
| | | yes | 6.66 | 5.22 | 2.17 |
| | talc | no | 2.12 | 1.37 | 1.72 |
| | | yes | 6.48 | 4.93 | 2.25 |
| | NaBz | no | 3.77 | 2.44 | 2.16 |
| | | yes | 8.49 | 7.19 | 3.47 |

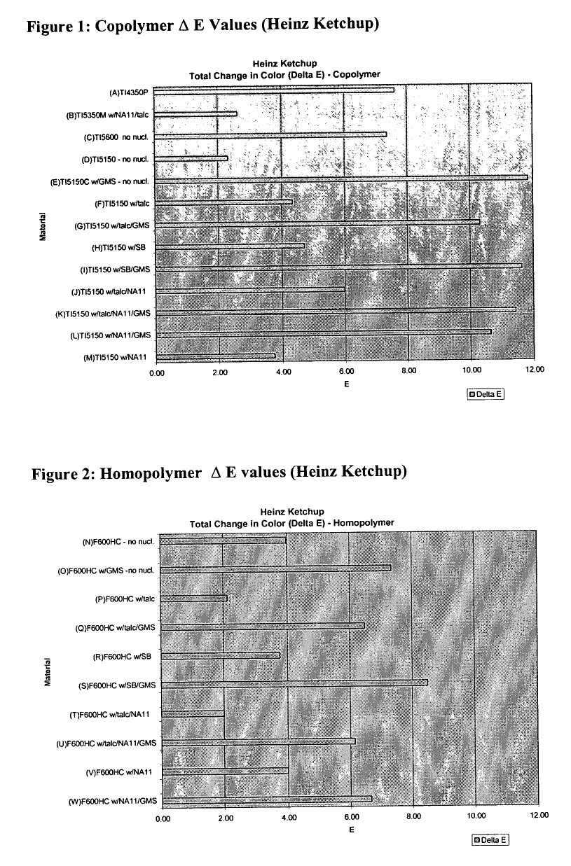

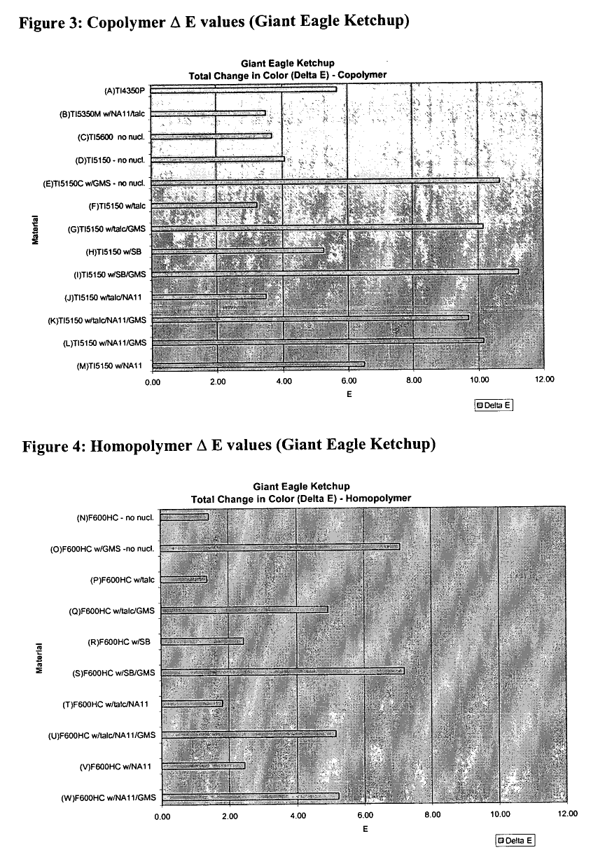

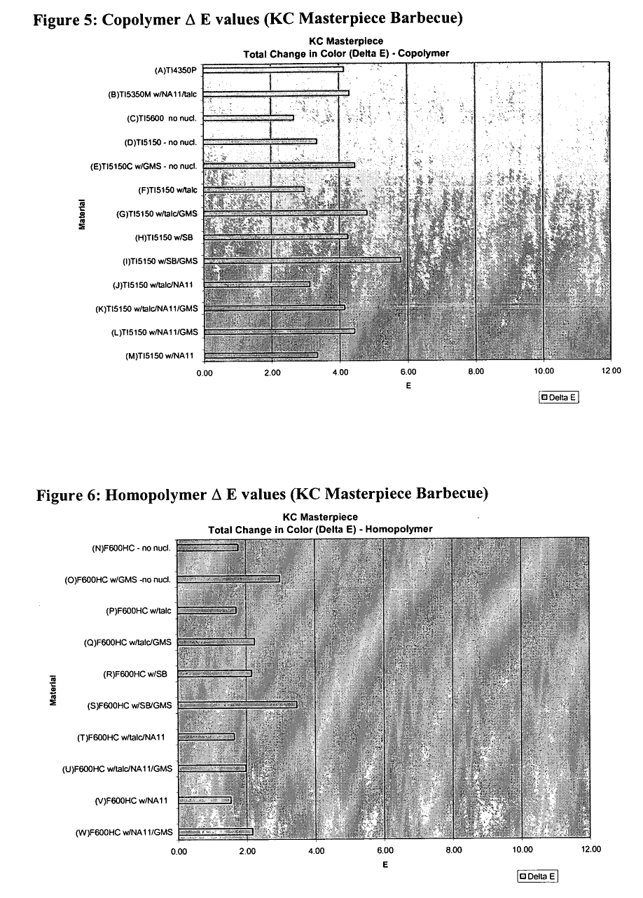

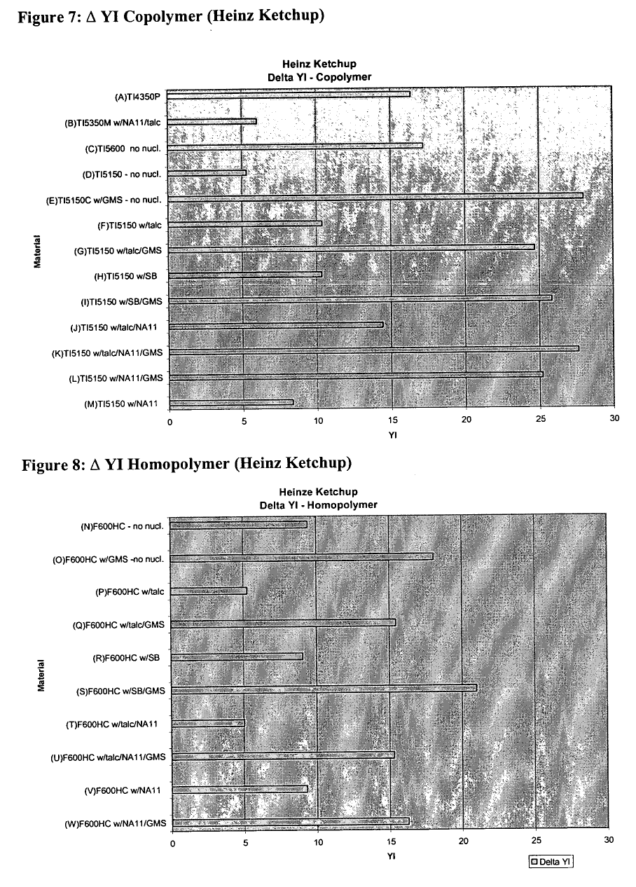

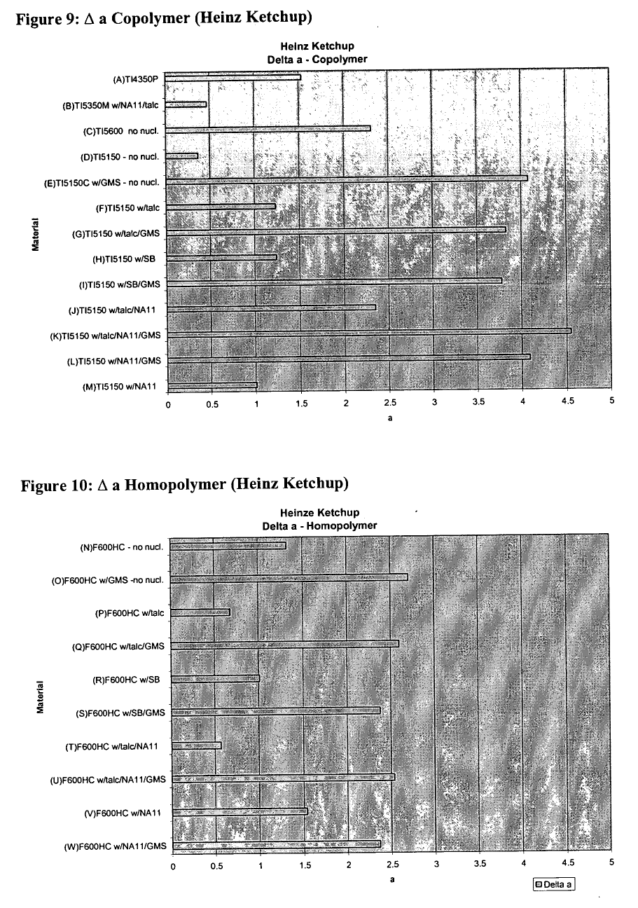

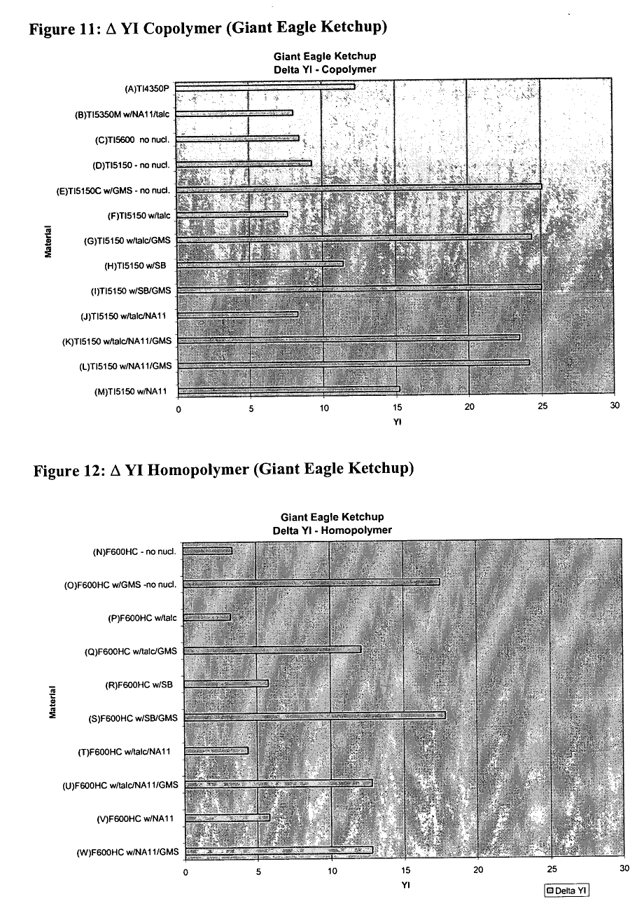

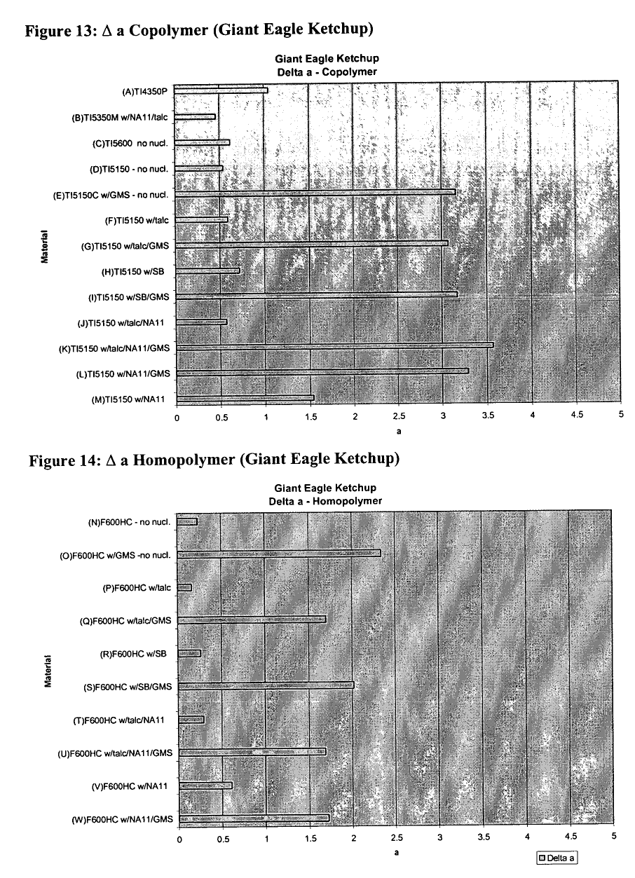

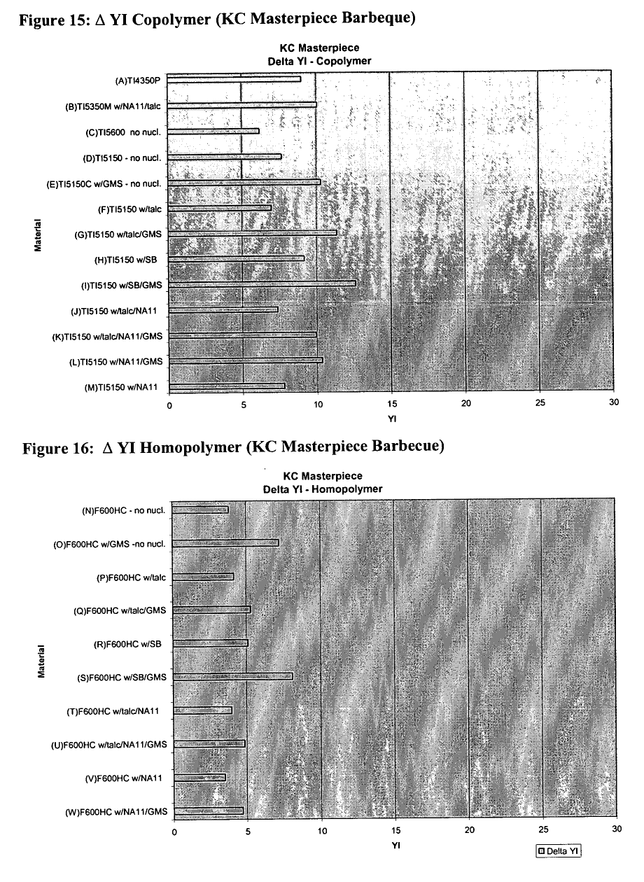

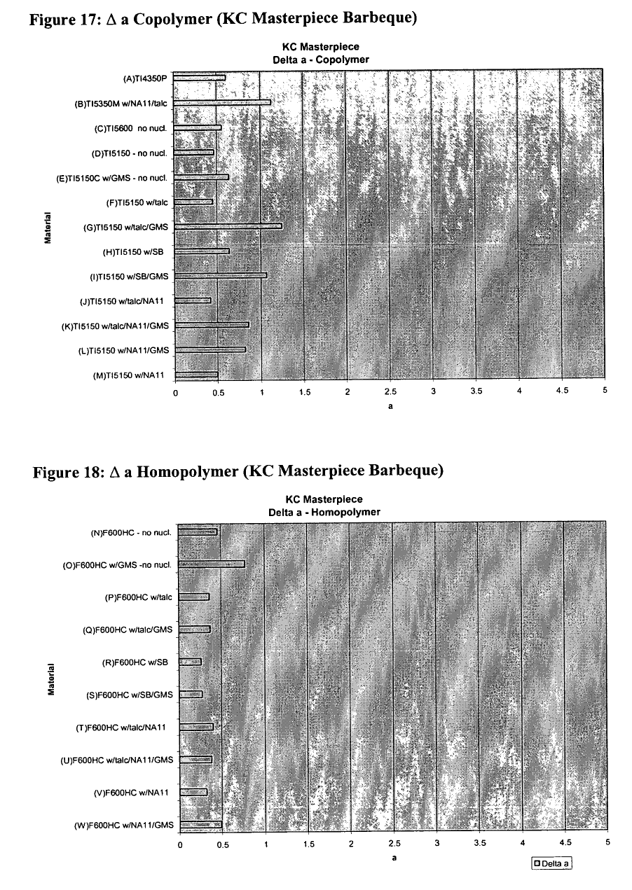

Other polypropylene compositions as indicated in Table II were prepared and the degree of staining was evaluated using the three different staining agents. The raw results for all trials are reported in Tables VII, VIII and IX and appended FIGS. 1-18.

TABLE VI
Raw Data (Heinz Ketchup) - Stain values in bold

Heinz Ketchup All
Measured Values

| Material | L | a | b | YI |
|---|---|---|---|---|
| F600HC w/NA11/GMS | 75.92 | −0.34 | 2.59 | 5.77 |
| F600HC w/NA11/GMS | 73.34 | 2.03 | 8.25 | 22.06 |
| F600HC w/NA11 | 76.06 | −0.32 | 2.9 | 6.52 |
| F600HC w/NA11 | 74.23 | 1.22 | 6.1 | 15.85 |
| F600HC w/talc/NA11/GMS | 75.73 | −0.36 | 3.3 | 7.45 |
| F600HC w/talc/NA11/GMS | 73.73 | 2.18 | 8.52 | 22.76 |
| F600HC w/talc/NA11 | 74.89 | −0.36 | 3.31 | 7.54 |
| F600HC w/talc/NA11 | 74.31 | 0.21 | 5.14 | 12.57 |
| F600HC w/SB/GMS | 75.41 | −0.18 | −2.02 | −4.96 |
| F600HC w/SB/GMS | 72.67 | 2.2 | 5.66 | 16.06 |
| F600HC w/SB | 74.9 | −0.08 | −1.91 | −4.64 |
| F600HC w/SB | 73.5 | 0.93 | 1.44 | 4.42 |
| F600HC w/talc/GMS | 76.38 | −0.22 | 3.24 | 7.37 |
| F600HC w/talc/GMS | 73.51 | 2.38 | 8.44 | 22.82 |
| F600HC w/talc | 76.35 | −0.27 | 3.51 | 7.96 |
| F600HC w/talc | 75.79 | 0.41 | 5.44 | 13.21 |
| F600HC w/GMS - no nucl. | 76.72 | −0.13 | 1.5 | 3.37 |
| F600HC w/GMS - no nucl. | 74.37 | 2.58 | 7.9 | 21.46 |
| F600HC - no nucl. | 76.46 | −0.11 | 1.45 | 3.27 |
| F600HC - no nucl. | 74.81 | 1.21 | 4.83 | 12.7 |
| TI5150 w/NA11 | 80.71 | −1.21 | −0.17 | −1.46 |
| TI5150 w/NA11 | 81.89 | −0.2 | 3.24 | 6.88 |
| TI5150 w/NA11/GMS | 80.66 | −1.24 | −1.67 | −4.79 |
| TI5150 w/NA11/GMS | 77.97 | 2.85 | 7.77 | 20.41 |
| TI5150 w/talc/NA11/GMS | 79.08 | −1.34 | −0.58 | −2.53 |
| TI5150 w/talc/NA11/GMS | 75.7 | 3.21 | 9.35 | 25.09 |
| TI5150 w/talc/NA11 | 79.07 | −1.3 | −0.13 | −1.47 |
| TI5150 w/talc/NA11 | 77.78 | 1.05 | 5.22 | 12.94 |
| TI5150 w/SB/GMS | 84.72 | −1.29 | −3.24 | −7.91 |
| TI5150 w/SB/GMS | 81.1 | 2.49 | 7.15 | 17.94 |
| TI5150 w/SB | 85.17 | −1.13 | −3.45 | −8.18 |
| TI5150 w/SB | 84.15 | 0.11 | 0.98 | 2.18 |
| TI5150 w/talc/GMS | 79.68 | −1.11 | −1.84 | −5.11 |
| TI5150 w/talc/GMS | 77.03 | 2.72 | 7.36 | 19.59 |
| TI5150 w/talc | 79.97 | −1.16 | −1.47 | −4.33 |
| TI5150 w/talc | 79.48 | 0.07 | 2.66 | 6.05 |
| TI5150C w/GMS - no nucl. | 80.95 | −0.95 | −2.71 | −6.82 |
| TI5150C w/GMS - no nucl. | 77.84 | 3.13 | 7.97 | 21.17 |
| TI5150 - no nucl. | 81.59 | −1.46 | −1.63 | −4.84 |
| TI5150 - no nucl. | 81.83 | −1.09 | 0.65 | 0.47 |
| TI5600 no nucl. | 80.32 | −0.92 | −2.59 | −6.57 |
| TI5600 no nucl. | 78.39 | 1.39 | 4.12 | 10.66 |
| TI5350M w/NA11/talc | 81.26 | −0.9 | −2.53 | −6.36 |
| TI5350M w/NA11/talc | 81.65 | −0.43 | 0.02 | −0.34 |
| TI4350P | 86.06 | −0.89 | −2.95 | −6.86 |
| TI4350P | 84.09 | 0.64 | 4.24 | 9.54 |

TABLE VII
Raw Data (Giant Eagle Ketchup) - Stain values in bold

Giant Eagle Ketchup
All Measured Values

| Material | L | a | b | YI |
|---|---|---|---|---|
| F600HC w/NA11/GMS | 75.92 | −0.34 | 2.59 | 5.77 |
| F600HC w/NA11/GMS | 73.99 | 1.38 | 7.13 | 18.55 |
| F600HC w/NA11 | 76.06 | −0.32 | 2.9 | 6.52 |
| F600HC w/NA11 | 75.1 | 0.29 | 5.07 | 12.32 |
| F600HC w/talc/NA11/GMS | 75.73 | −0.36 | 3.3 | 7.45 |
| F600HC w/talc/NA11/GMS | 74.03 | 1.33 | 7.86 | 20.25 |
| F600HC w/talc/NA11 | 74.89 | −0.36 | 3.31 | 7.54 |
| F600HC w/talc/NA11 | 74.25 | −0.07 | 4.98 | 11.9 |
| F600HC w/SB/GMS | 75.41 | −0.18 | −2.02 | −4.96 |
| F600HC w/SB/GMS | 73.3 | 1.84 | 4.56 | 12.9 |
| F600HC w/SB | 74.9 | −0.08 | −1.91 | −4.64 |
| F600HC w/SB | 74.2 | 0.18 | 0.41 | 1.15 |
| F600HC w/talc/GMS | 76.38 | −0.22 | 3.24 | 7.37 |
| F600HC w/talc/GMS | 74.71 | 1.48 | 7.56 | 19.47 |
| F600HC w/talc | 76.35 | −0.27 | 3.51 | 7.96 |
| F600HC w/talc | 75.91 | −0.11 | 4.8 | 11.2 |
| F600HC w/GMS - no nucl. | 76.72 | −0.13 | 1.5 | 3.37 |
| F600HC w/GMS - no nucl. | 74.67 | 2.21 | 7.87 | 20.92 |
| F600HC - no nucl. | 76.46 | −0.11 | 1.45 | 3.27 |
| F600HC - no nucl. | 75.97 | 0.12 | 2.78 | 6.66 |
| TI5150 w/NA11 | 80.71 | −1.21 | −0.17 | −1.46 |
| TI5150 w/NA11 | 79.29 | 0.33 | 5.97 | 13.76 |
| TI5150 w/NA11/GMS | 80.66 | −1.24 | −1.67 | −4.79 |
| TI5150 w/NA11/GMS | 78.41 | 2.05 | 7.67 | 19.35 |
| TI5150 w/talc/NA11/GMS | 79.08 | −1.34 | −0.58 | −2.53 |
| TI5150 w/talc/NA11/GMS | 76.73 | 2.23 | 8.12 | 20.97 |
| TI5150 w/talc/NA11 | 79.07 | −1.3 | −0.13 | −1.47 |
| TI5150 w/talc/NA11 | 79.05 | −0.73 | 3.31 | 6.81 |
| TI5150 w/SB/GMS | 84.72 | −1.29 | −3.24 | −7.91 |
| TI5150 w/SB/GMS | 81.52 | 1.88 | 7.06 | 17.11 |
| TI5150 w/SB | 85.17 | −1.13 | −3.45 | −8.18 |
| TI5150 w/SB | 84.37 | −0.41 | 1.7 | 3.25 |
| TI5150 w/talc/GMS | 79.68 | −1.11 | −1.84 | −5.11 |
| TI5150 w/talc/GMS | 77.32 | 1.96 | 7.55 | 19.24 |
| TI5150 w/talc | 79.97 | −1.16 | −1.47 | −4.33 |
| TI5150 w/talc | 79.97 | −0.57 | 1.71 | 3.31 |
| TI5150C w/GMS - no nucl. | 80.95 | −0.95 | −2.71 | −6.82 |
| TI5150C w/GMS - no nucl. | 78.3 | 2.21 | 7.13 | 18.28 |
| TI5150 - no nucl. | 81.59 | −1.46 | −1.63 | −4.84 |
| TI5150 - no nucl. | 81.42 | −0.92 | 2.41 | 4.47 |
| TI5600 no nucl. | 80.32 | −0.92 | −2.59 | −6.57 |
| TI5600 no nucl. | 79.55 | −0.3 | 0.96 | 1.89 |
| TI5350M w/NA11/talc | 81.26 | −0.9 | −2.53 | −6.36 |
| TI5350M w/NA11/talc | 81.43 | −0.44 | 0.94 | 1.69 |
| TI4350P | 86.06 | −0.89 | −2.95 | −6.86 |
| TI4350P | 84.98 | 0.16 | 2.53 | 5.45 |

TABLE VIII
Raw Data (KC Masterpiece) - Stain values in bold

KC Masterpiece Barbecue
Sauce All Measured Values

| Material | L | a | b | YI |
|---|---|---|---|---|
| F600HC w/NA11/GMS | 75.92 | −0.34 | 2.59 | 5.77 |
| F600HC w/NA11/GMS | 74.71 | 0.15 | 4.32 | 10.47 |
| F600HC w/NA11 | 76.06 | −0.32 | 2.9 | 6.52 |
| F600HC w/NA11 | 75.36 | 0 | 4.23 | 10.02 |
| F600HC w/talc/NA11/GMS | 75.73 | −0.36 | 3.3 | 7.45 |
| F600HC w/talc/NA11/GMS | 75.21 | 0.02 | 5.17 | 12.3 |
| F600HC w/talc/NA11 | 74.89 | −0.36 | 3.31 | 7.54 |
| F600HC w/talc/NA11 | 74.24 | 0.04 | 4.77 | 11.51 |
| F600HC w/SB/GMS | 75.41 | −0.18 | −2.02 | −4.96 |
| F600HC w/SB/GMS | 74.35 | 0.09 | 1.27 | 3.13 |
| F600HC w/SB | 74.9 | −0.08 | −1.91 | −4.64 |
| F600HC w/SB | 74.21 | 0.18 | 0.12 | 0.46 |
| F600HC w/talc/GMS | 76.38 | −0.22 | 3.24 | 7.37 |
| F600HC w/talc/GMS | 75.54 | 0.15 | 5.29 | 12.66 |
| F600HC w/talc | 76.35 | −0.27 | 3.51 | 7.96 |
| F600HC w/talc | 75.84 | 0.09 | 5.11 | 12.12 |
| F600HC w/GMS - no nucl. | 76.72 | −0.13 | 1.5 | 3.37 |
| F600HC w/GMS - no nucl. | 75.77 | 0.65 | 4.22 | 10.55 |
| F600HC - no nucl. | 76.46 | −0.11 | 1.45 | 3.27 |
| F600HC - no nucl. | 75.47 | 0.35 | 2.86 | 7.09 |
| TI5150 w/NA11 | 80.71 | −1.21 | −0.17 | −1.46 |
| TI5150 w/NA11 | 80.54 | −0.71 | 3.13 | 6.32 |
| TI5150 w/NA11/GMS | 80.66 | −1.24 | −1.67 | −4.79 |
| TI5150 w/NA11/GMS | 80.24 | −0.42 | 2.67 | 5.57 |
| TI5150 w/talc/NA11/GMS | 79.08 | −1.34 | −0.58 | −2.53 |
| TI5150 w/talc/NA11/GMS | 78.66 | −0.48 | 3.46 | 7.42 |
| TI5150 w/talc/NA11 | 79.07 | −1.3 | −0.13 | −1.47 |
| TI5150 w/talc/NA11 | 79.14 | −0.88 | 2.96 | 5.88 |
| TI5150 w/SB/GMS | 84.72 | −1.29 | −3.24 | −7.91 |
| TI5150 w/SB/GMS | 83.3 | −0.22 | 2.28 | 4.7 |
| TI5150 w/SB | 85.17 | −1.13 | −3.45 | −8.18 |
| TI5150 w/SB | 84.29 | −0.49 | 0.65 | 0.97 |
| TI5150 w/talc/GMS | 79.68 | −1.11 | −1.84 | −5.11 |
| TI5150 w/talc/GMS | 78.63 | 0.14 | 2.69 | 6.25 |
| TI5150 w/talc | 79.97 | −1.16 | −1.47 | −4.33 |
| TI5150 w/talc | 79.92 | −0.71 | 1.46 | 2.64 |
| TI5150C w/GMS - no nucl. | 80.95 | −0.95 | −2.71 | −6.82 |
| TI5150C w/GMS - no nucl. | 80.56 | −0.31 | 1.69 | 3.49 |
| TI5150 - no nucl. | 81.59 | −1.46 | −1.63 | −4.84 |
| TI5150 - no nucl. | 81.43 | −0.99 | 1.68 | 2.81 |
| TI5600 no nucl. | 80.32 | −0.92 | −2.59 | −6.57 |
| TI5600 no nucl. | 79.82 | −0.36 | −0.03 | −0.38 |
| TI5350M w/NA11/talc | 81.26 | −0.9 | −2.53 | −6.36 |
| TI5350M w/NA11/talc | 80.76 | 0.23 | 1.59 | 3.71 |
| TI4350P | 86.06 | −0.89 | −2.95 | −6.86 |
| TI4350P | 85.62 | −0.28 | 1.13 | 2.12 |

The data collected on the initial samples demonstrated that homopolymers display better stain resistance than copolymers. The initial data also display that certain copolymers display better stain resistance than others. Further, the data indicate that specific additives, especially talc as a nucleating agent greatly enhance the stain resistance of copolymers. The data further indicate that the presence of certain additives, such as sodium compounds like sodium benzoate and NA-11, slip agents, such as glycerol monostearate is detrimental to the stain resistance of the materials.

Additional trials were done with additional copolymers and additives. The copolymers used in the additional trials were TI5150, TI4150 and TI3120. TI3120 is a 12 MFR random copolymer. In addition, trials were completed using a visbroken sample of TI5150. The additional trials focused on the use of talc as a nucleating agent, along with additional additives such as a hydrotalcite like material, DHT-4A, as an acid scavenger. A trial was also completed with an alternative sodium containing nucleating agent HPN-68, from Milliken Chemical. The trials for each formulation were run in triplicate, the data reported are averages of three trials for each sample. The staining agents used for the trials were Heinz Ketchup and KC Master Piece Barbeque Sauce.

The data for each blend are shown in Table IX. The data in Table IX demonstrate that formulation A had the best stain resistance properties. The superior performance of formulation A can be attributed to a combination of the properties of the polyolefin itself and the additive package used. Comparing formulation A with formulations C, D and H it can be seen that where the same additive package is used, differences in the xylene solubles between polyolefins has a significant impact on stain resistance. Specifically, the xylene solubles in formulation A display a higher intrinsic viscosity (IV) and a higher weight average molecular weight (Mw/1000) compared to formulations C, D and H. Both of these values indicate the presence of higher molecular weight species in the xylene solubles of formulation A. It can be seen from the data that formulation A performed better than formulations C, D and H with respect to both Δ E and YI. This is despite the fact that both formulations C and H actually have a lower percentage of xylene solubles.

TABLE IX

| | A | C | D | E | F | G | H |
|---|---|---|---|---|---|---|---|
| powder | 5150 | B-4150 | C-4150 | 5150 | 5150 | 5150 | 3120 |
| DSTDP (TPS) | 0.5 | 0.5 | 0.5 | 0.5 | 0.5 | 0.5 | 0.5 |
| Irganox 1010 (FF) | 0.1 | 0.1 | 0.1 | 0.1 | 0.1 | 0.1 | 0.1 |
| Irgafos 168 | 0.08 | 0.08 | 0.08 | | 0.08 | 0.08 | 0.08 |
| DHT-4A | 0.02 | 0.02 | 0.02 | 0.02 | 0.02 | | 0.02 |
| Talc | 0.3 | 0.3 | 0.3 | 0.3 | | 0.3 | 0.3 |
| CaSt2 | | | | | | 0.05 | |
| HPN68 | | | | | 0.1 | | |
| T101 | | | | | | 0.01 | |
| MFR | 16.30 | 17.70 | 15.80 | 19.10 | 15.80 | 38.30 | 14.70 |
| % XS | 7.04 | 6.88 | 8.91 | 6.83 | 8.02 | 7.86 | 4.32 |
| % C2 total | 3.4 | 3.0 | 5.5 | 3.4 | 3.7 | 3.5 | 2.4 |
| IV | 3.00 | 2.87 | 1.99 | 2.98 | 4.00 | 2.13 | 0.42 |
| Mn/1000-xs | 56.8 | 48.5 | 47.5 | 55.7 | 66.3 | 62.8 | 7.3 |
| Mw/1000 | 403 | 308 | 225 | 395 | 509 | 286 | 36 |
| Mz/1000 | 1092 | 782 | 538 | 975 | 1982 | 699 | 211 |
| D | 7.09 | 6.35 | 4.74 | 7.09 | 7.68 | 4.55 | 4.90 |
| Tₘ | 165.0 | 165.2 | 165.1 | 165.2 | 166.5 | 164.4 | 150.2 |
| | | | 118.1 | | | | |
| T_{c} | 121.8 | 122.3 | 122.3 | 121.6 | 127.7 | 122.5 | 111.2 |
| | | | 97.5 | | | | |
| % X_{c} | 54.0 | 55.4 | 53.9 | 54.3 | 56.4 | 56.3 | 46.7 |
| ΔE - HK YI | 6.18 | 6.95 | 7.18 | 6.92 | 7.48 | 7.61 | 14.96 |
| | 14.03 | 15.96 | 16.09 | 15.62 | 16.67 | 17.32 | 36.73 |
| ΔE - BBQ YI | 6.60 | 7.45 | 7.21 | 7.03 | 7.37 | 7.28 | 8.69 |
| | 14.90 | 17.10 | 16.05 | 15.88 | 16.44 | 16.50 | 20.47 |

HK = Heinz Ketchup,
BBQ = Master Piece Barbeque Sauce

The impact of variations in the additives included in the formulation can be seen by comparing formulation A with formulations E and F. All three formulations were prepared using the same polyolefin, but altering the additive package used. Comparing formulation A to formulation E, it can be seen that the xylene solubles in formulation E have IV and Mw values that are similar to formulation A. The inferior performance of formulation E, both in terms of Δ E and YI can be linked to the absence of the secondary anti-oxidant Irgafos 168. The xylene solubles in formulation F display IV and Mw numbers that are higher than those in formulation A, indicating the presence of higher molecular weight species. However, the sample displays worse performance both in terms of Δ E and YI. This can be attributed to the absence of talc in the formulation and the presence of HPN-68, a sodium based nucleating agent. As the preliminary study predicted, the presence of sodium compounds is detrimental to stain resistance.

Overall, the data from both studies indicate that although copolymers cannot match the stain resistant characteristics of high crystalline homopolymers, acceptable stain resistance can be achieved in copolymers by controlling characteristics of the xylene solubles and by providing the appropriate additive package. Specifically, the data indicate that the higher the IV and Mw of the xylene solubles, the greater the stain resistance of the polyolefin. The data indicate that this is true independent of the actual quantity of xylene solubles as a percentage of the polyolefin. Preferred embodiments of the polyolefins according to the invention would have xylene solubles having IVs greater than about 3.0 and (Mw/1000) greater than about 350. More preferably the (Mw/1000) of the polyolefins would be greater than about 400.

With regard to the additive packages used, the data indicate that the presence of talc in the formulation is important to stain resistance, and conversely that the presence of sodium containing compounds is detrimental. Further, the presence of primary and secondary antioxidants enhances stain resistance.

An additional set of tests were run using a variety of 35 melt flow high crystalline homopolymers compounded with various additives in the formulations to confirm the results obtained using nucleating agents. The additives used were: nucleating agents such as talc, HPN-68®, MILLAD 3988® (both available from Milliken Chemical), MOLDPRO® 931 (available from Crompton Corporation) and adipic acid; CARSTAB® DSTDP (available from Struktol) for long term heat stability; and acid scavengers such as DHT-4A and calcium stearate. Plaques were molded and stained with either Heinz Ketchup or KC Masterpiece BBQ Sauce, and then color was tested on the stained plaques as well as the unstained plaques for reference. The formulations used are summarized in Table X. All of the formulations contained 500 ppm of Irganox 1010 and 500 ppm Irgafos 168.

TABLE X

| | 1 | 2 | 3 | 4 | 5 | 6 | 7 | 8 | 9 |
|---|---|---|---|---|---|---|---|---|---|
| Talc | 3000 | 3000 | | | | | | | |
| HPN68 | | | | 1000 | | | | | |
| Millad | | | | | | 1600 | | | |
| 3988 | | | | | | | | | |
| MoldPro | | | | | | | 800 | | |
| 931 | | | | | | | | | |
| Adipic | | | | | | | | 400 | |
| Acid | | | | | | | | | |
| DHT-4A | 200 | 200 | 200 | 200 | | | | | 500 |
| DSTDP | | 500 | | | | | | | |
| CaSt | | | | | 500 | 500 | 500 | 500 | |
| ΔYI | 5.71 | 6.10 | 4.21 | 5.25 | 4.33 | 6.14 | 5.58 | 6.25 | 3.99 |
| (HK) | | | | | | | | | |
| ΔE (HK) | 2.87 | 2.62 | 1.83 | 2.22 | 1.80 | 2.61 | 2.38 | 2.62 | 1.73 |
| ΔYI | 8.38 | 10.09 | 9.81 | 9.94 | 9.80 | 8.75 | 9.55 | 8.76 | 8.24 |
| (BBQ) | | | | | | | | | |
| ΔE(BBQ) | 4.03 | 4.26 | 4.23 | 4.16 | 4.16 | 3.71 | 4.11 | 3.69 | 3.49 |

all concentrations of additives are in ppm
HK = Heinz Ketchup
BBQ = Barbeque Sauce

The data in Table X indicate that the use of nucleating agents in crystalline propylene homopolymers does not have the same beneficial effect that it has in copolymers. With respect to the samples stained with Heinz Ketchup, the presence of a nucleating agent was actually detrimental.

1. A household article exhibiting enhanced resistance to staining, said household article comprising:
a nucleated propylene/ethylene impact copolymer having an ethylene content of up to about 15 percent by weight, and a xylene solubles fraction having an intrinsic viscosity of at least 3 dL/g;
wherein said xylene soluble fraction has a molecular weight (Mw/1000) of at least about 350;
said propylene/ethylene copolymer containing an additive package consisting essentially of: a phenolic antioxidant, a phosphite, and an acid scavenger;
said household article being essentially free of sodium containing additives.

2. The household article according to claim 1, wherein said propylene/ethylene impact copolymer is nucleated with talc.

3. The household article according to claim 1, wherein said acid scavenger is selected from the group consisting of: hydrotalcite like materials and calcium stearate.

4. The household article according to claim 1, wherein said propylene/ethylene impact copolymer further contains a thiosynergist.

5. The household article according to claim 4, wherein said propylene/ethylene impact copolymer contains the following amounts of each additive by weight based on said propylene/ethylene impact copolymer:
from about 1000 to about 3000 ppm of a nucleating agent;
from about 500 to about 1000 ppm of said phenolic antioxidant;
from about 500 to about 800 ppm of said phosphite;
up to 5000 ppm of said thiosynergist; and
from about 200 to about 500 ppm of said acid scavenger.

6. The household article according to claim 4, wherein said household article is a component for a household appliance.

7. A method for producing a household article displaying improved stain resistance characteristics, said method comprising:
providing a nucleated propylene/ethylene impact copolymer having an ethylene content of up to 15 percent by weight, and a xylene solubles fraction having an intrinsic viscosity of at least 3 dL/g;
wherein said xylene soluble fraction has an Mw/1000 of at least about 350;
adding an additive package to said propylene/ethylene copolymer, said additive package consisting essentially of a phenolic antioxidant, a phosphite, and an acid scavenger, said phenolic antioxidant, phosphite, and acid scavenger being essentially free of sodium;
wherein said propylene/ethylene impact copolymer is nucleated with a nucleating agent that is essentially free of sodium;
forming said propylene/ethylene impact copolymer into a household article.

8. The method according to claim 7, wherein said propylene/ethylene impact copolymer is nucleated with talc.

9. The method according to claim 7, further comprising the step of adding a thiosynergist to said propylene/ethylene impact copolymer.

10. The method according to claim 9, wherein said propylene/ethylene impact copolymer contains the following amounts of each additive by weight based on said propylene/ethylene impact copolymer:
from about 1000 to about 3000 ppm of a nucleating agent;
from about 500 to about 1000 ppm of said phenolic antioxidant;
from about 500 to about 800 ppm of said phosphite;
up to 5000 ppm of said thiosynergist; and
from about 200 to about 500 ppm of said acid scavenger.

11. The method according to claim 9, wherein said household article is a component for a household appliance.

12. A household article exhibiting enhanced stain resistance, said household article comprising:
a propylene homopolymer having a crystallinity of at least about 55 percent,
said propylene polymer containing an additive package consisting essentially of: a phenolic antioxidant, a phosphite, and an acid scavenger;
said household article being essentially free of sodium containing additives.

13. The household article according to claim 12, wherein said acid scavenger is selected from the group consisting of: hydrotalcite like materials and calcium stearate.

14. The molded household article according to claim 12, wherein said propylene homopolymer further contains a thiosynergist.

15. The molded household article according to claim 14, wherein said propylene homopolymer contains the following amounts of each additive by weight based on said propylene homopolymer:
from about 500 to about 1000 ppm of said phenolic antioxidant;
from about 500 to about 800 ppm of said phosphite;
up to 5000 ppm of said thiosynergist; and
from about 200 to about 500 ppm of said acid scavenger.

16. The household article according to claim 14, wherein said household article is a component for a household appliance.

17. A composition for producing household articles exhibiting enhanced resistance to staining, said composition comprising:
a nucleated propylene/ethylene impact copolymer having an ethylene content of up to about 15 percent by weight, and a xylene solubles fraction having an intrinsic viscosity of at least 3 dL/g;
wherein said xylene soluble fraction has a molecular weight (Mw/1000) of at least about 350;
said propylene/ethylene impact copolymer containing an additive package consisting essentially of: a phenolic antioxidant, a phosphite, and an acid scavenger;
said composition being essentially free of sodium containing additives.

18. The composition according to claim 17, wherein said acid scavenger is selected from the group consisting of: hydrotalcite like materials and calcium stearate.

19. The composition according to claim 17, wherein said propylene/ethylene impact copolymer further contains a thiosynergist.

20. The composition according to claim 19, wherein said propylene/ethylene impact copolymer contains the following amounts of each additive by weight based on said propylene/ethylene impact copolymer:
from about 1000 to about 3000 ppm of a nucleating agent;
from about 500 to about 1000 ppm of said phenolic antioxidant;
from about 500 to about 800 ppm of said phosphite;
up to 5000 ppm of said thiosynergist; and
from about 200 to about 500 ppm of said acid scavenger.

21. A composition for producing household articles exhibiting enhanced resistance to staining, said composition comprising:
a propylene homopolymer having a crystallinity of at least about 55 percent,
said propylene polymer containing an additive package consisting essentially of: a phenolic antioxidant, a phosphite, and an acid scavenger;
said composition being essentially free of sodium containing additives.

22. The composition according to claim 21, wherein said acid scavenger is selected from the group consisting of: hydrotalcite like materials and calcium stearate.

23. The composition according to claim 21, wherein said propylene homopolymer further contains a thiosynergist.

24. The composition according to claim 23, wherein said propylene homopolymer contains the following amounts of each additive by weight based on said propylene homopolymer:
from about 500 to about 1000 ppm of said phenolic antioxidant;
from about 500 to about 800 ppm of said phosphite;
up to 5000 ppm of said thiosynergist; and
from about 200 to about 500 ppm of said acid scavenger.
